(19) United States
(12) Patent Application Publication
(10) Pub. No.: US 2024/0073530 A1
(43) Pub. Date: Feb. 29, 2024

(54) SYSTEM AND METHOD FOR CONTROLLING A CAMERA BASED ON THREE-DIMENSIONAL LOCATION DATA

(71) Applicant: REVLOGICAL, LLC, NORTH KANSAS CITY, MO (US)

(72) Inventors: RYAN WAGER, WEATHERBY LAKE, MO (US); RHETT PLACE, OVERLAND PARK, KS (US)

(21) Appl. No.: 17/898,875

(22) Filed: Aug. 30, 2022

(51) Int. Cl. H04N 5/232; G06K 7/10; H04N 7/18

(52) U.S. Cl. CPC H04N 5/23299; G06K 7/10475; H04N 5/23206; H04N 7/183; H04N 5/23216

(57) ABSTRACT

A system and method for controlling a camera based on three-dimensional location data is disclosed. The system receives a request to view a target object and determines a set of three-dimensional Cartesian coordinates (X, Y, Z) representative of a first position of the target object relative to a second position of the camera. The system converts the set of three-dimensional Cartesian coordinates (X, Y, Z) to a set of spherical coordinates (r, θ, φ) and generates a pan-tilt-zoom command based on the set of spherical coordinates (r, θ, φ). The system transmits the pan-tilt-zoom command to the camera whereby the camera is automatically adjusted to broadcast a video stream of the target object.

### CROSS-REFERENCE TO RELATED APPLICATIONS

Not applicable.

### STATEMENT REGARDING FEDERALLY SPONSORED RESEARCH OR DEVELOPMENT

Not applicable.

### STATEMENT REGARDING JOINT RESEARCH AGREEMENT

Not applicable.

### BACKGROUND OF THE INVENTION

Real-time locating systems (RTLS) are used to automatically determine the location of objects of interest, usually within a building or other contained area. These systems include readers spread across the contained area that are used to receive wireless signals from tags attached to the objects of interest. The information contained in these signals is processed to determine the two-dimensional or three-dimensional location of each of the objects of interest. While RTLS systems provide location information that is sufficient for certain purposes, they are not generally compatible with camera systems used to view the contained area or particular objects of interest. Therefore, there remains a need in the art for a technological solution that offers features, functionality or other advantages not provided by existing RTLS or camera systems.

### BRIEF SUMMARY OF THE INVENTION

The present invention is directed to a system and method for controlling one or more cameras based on three-dimensional location data for each of one or more target objects. The three-dimensional location data may be provided by an RTLS system. For each target object, the system determines a set of three-dimensional Cartesian coordinates (X, Y, Z) representative of a first position of a target object relative to a second position of a camera. The system converts the set of three-dimensional Cartesian coordinates (X, Y, Z) to a set of spherical coordinates (r, θ, φ) and generates a pan-tilt-zoom command based on the set of spherical coordinates (r, θ, φ). The system transmits the pan-tilt-zoom command to the camera whereby the camera is automatically adjusted to broadcast a video stream of the target object. The invention may be used to control a variety of different types of cameras, such as a pan-tilt-zoom (PTZ) camera, an electronic pan-tilt-zoom (ePTZ) camera, or any other type of camera capable of being controlled by a pan-tilt-zoom command.

An automated camera system for broadcasting video streams of target objects stored in a warehouse in accordance with one embodiment of the invention described herein includes at least one camera positioned within the warehouse. The system also includes a control system in communication with the camera, wherein the control system is configured to: receive a request to view a target object located in the warehouse; determine a set of three-dimensional Cartesian coordinates (X, Y, Z) representative of a first position of the target object relative to a second position of the camera; convert the set of three-dimensional Cartesian coordinates (X, Y, Z) to a set of spherical coordinates (r, θ, φ); generate a pan-tilt-zoom command based on the set of spherical coordinates (r, θ, φ); and transmit the pan-tilt-zoom command to the camera. The camera, responsive to receipt of the pan-tilt-zoom command, is automatically adjusted to broadcast a video stream of the target object.

An automated camera system in accordance with another embodiment of the invention described herein includes a camera configured for automatic adjustment between a plurality of fields of view. The system also includes a control system in communication with the camera, wherein the control system is configured to: determine a first set of three-dimensional Cartesian coordinates (Xₒ, Yₒ, Zₒ) representative of a first position of a target object relative to a reference position within a viewing region; determine a second set of three-dimensional Cartesian coordinates (X_{c}, Y_{c}, Z_{c}) representative of a second position of the camera relative to the reference position within the viewing region; determine a third set of three-dimensional Cartesian coordinates (X, Y, Z) representative of the first set of three-dimensional Cartesian coordinates (Xₒ, Yₒ, Zₒ) relative to the second set of three-dimensional Cartesian coordinates (X_{c}, Y_{c}, Z_{c}); convert the third set of three-dimensional Cartesian coordinates (X, Y, Z) to a set of spherical coordinates (r, θ, φ); generate a camera command based on the set of spherical coordinates (r, θ, φ); and transmit the camera command to the camera. The camera, responsive to receipt of the camera command, is automatically adjusted to provide a field of view that includes the target object.

A method of automatically controlling a camera to provide a video stream of a target object in accordance with yet another embodiment of the invention described herein includes the steps of: determining a set of three-dimensional Cartesian coordinates (X, Y, Z) representative of a first position of the target object relative to a second position of the camera; converting the set of three-dimensional Cartesian coordinates (X, Y, Z) to a set of spherical coordinates (r, θ, φ); generating a camera command based on the set of spherical coordinates (r, θ, φ); and transmitting the camera command to the camera whereby the camera is automatically adjusted to broadcast a video stream of the target object.

Various embodiments of the present invention are described in detail below, or will be apparent to one skilled in the art based on the disclosure provided herein, or may be learned from the practice of the invention. It should be understood that the above brief summary of the invention is not intended to identify key features or essential components of the embodiments of the present invention, nor is it intended to be used as an aid in determining the scope of the claimed subject matter as set forth below.

### BRIEF DESCRIPTION OF THE DRAWINGS

A detailed description of various exemplary embodiments of the present invention is provided below with reference to the following drawings, in which:

FIG. 1 is a network diagram of an automated camera system for locating and broadcasting video streams of target objects stored in a warehouse in accordance with one embodiment of the invention;

FIG. 2 is a top view of an exemplary layout of a warehouse that utilizes the automated camera system of FIG. 1;

FIG. 3 is a process flow diagram of an exemplary method for collecting three-dimensional location data for the objects stored in the warehouse FIG. 2;

FIG. 4 is a process flow diagram of an exemplary method for processing a request to locate and view a target object stored in the warehouse of FIG. 2;

FIG. 5 is a process flow diagram of an exemplary method for converting three-dimensional location data for a target object to a pan-tilt-zoom command that enables a camera to broadcast a video stream of the target object; and

FIG. 6 is a screen shot of a user interface presented on one of the computing devices of FIG. 1 showing a video stream of the target object.

### DETAILED DESCRIPTION OF EXEMPLARY EMBODIMENTS

The present invention is directed to a system and method for controlling one or more cameras based on three-dimensional location data for each of one or more target objects. While the invention will be described in detail below with reference to various exemplary embodiments, it should be understood that the invention is not limited to the specific configurations or methods of any of these embodiments. In addition, although the exemplary embodiments are described as embodying several different inventive features, those skilled in the art will appreciate that any one of these features could be implemented without the others in accordance with the invention.

In the present disclosure, references to “one embodiment,” “an embodiment,” “an exemplary embodiment,” or “embodiments” mean that the feature or features being described are included in at least one embodiment of the invention. Separate references to “one embodiment,” “an embodiment,” “an exemplary embodiment,” or “embodiments” in this disclosure do not necessarily refer to the same embodiment and are also not mutually exclusive unless so stated and/or except as will be readily apparent to one skilled in the art from the description. For example, a feature, structure, function, etc. described in one embodiment may also be included in other embodiments, but is not necessarily included. Thus, the present invention can include a variety of combinations and/or integrations of the embodiments described herein.

An exemplary embodiment of the present invention will now be described in which an automated camera system is used for locating and broadcasting video streams of target objects stored in a warehouse. It should be understood that the invention is not limited to the warehouse implementation described below and that the automated camera system could be used in a variety of different implementations. For example, the automated camera system could be used to view any object given a known three-dimensional location, such as items in a store, animals in a pen, people in a room, cars on a car lot, trees in an orchard, etc. Of course, other implementations will be apparent to one skilled in the art.

### System Configuration

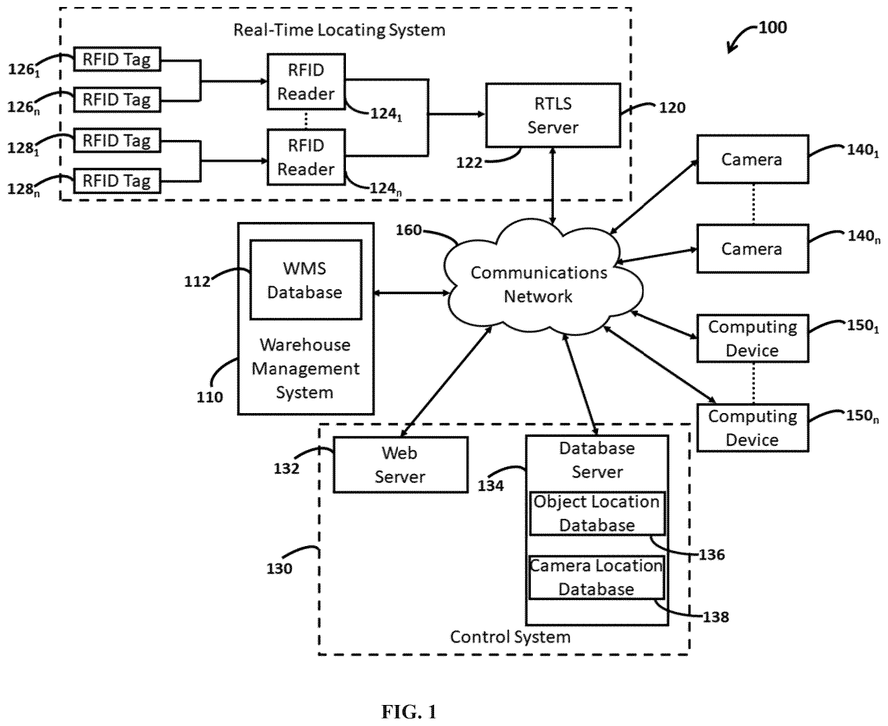

Referring to FIG. 1, an automated camera system for locating and broadcasting video streams of target objects stored in a warehouse in accordance with one embodiment of the present invention is shown generally as reference number 100. In general terms, system 100 includes a plurality of network elements-including a warehouse management system 110, a real-time locating system 120, a control system 130 (which includes a web server 132 and a database server 134), one or more cameras 140₁-140ₙ, and one or more computing devices 150₁-150ₙ-which communicate with each other via a communications network 160. Each of the network elements shown in FIG. 1 will be described in greater detail below.

Communications network 160 may comprise any network or combination of networks capable of facilitating the exchange of data among the network elements of system 100. In some embodiments, communications network 160 enables communication in accordance with the IEEE 802.3 protocol (e.g., Ethernet) and/or the IEEE 802.11 protocol (e.g., Wi-Fi). In other embodiments, communications network 160 enables communication in accordance with one or more cellular standards, such as the Long-Term Evolution (LTE) standard, the Universal Mobile Telecommunications System (UMTS) standard, and the like. Of course, other types of networks may also be used within the scope of the present invention.

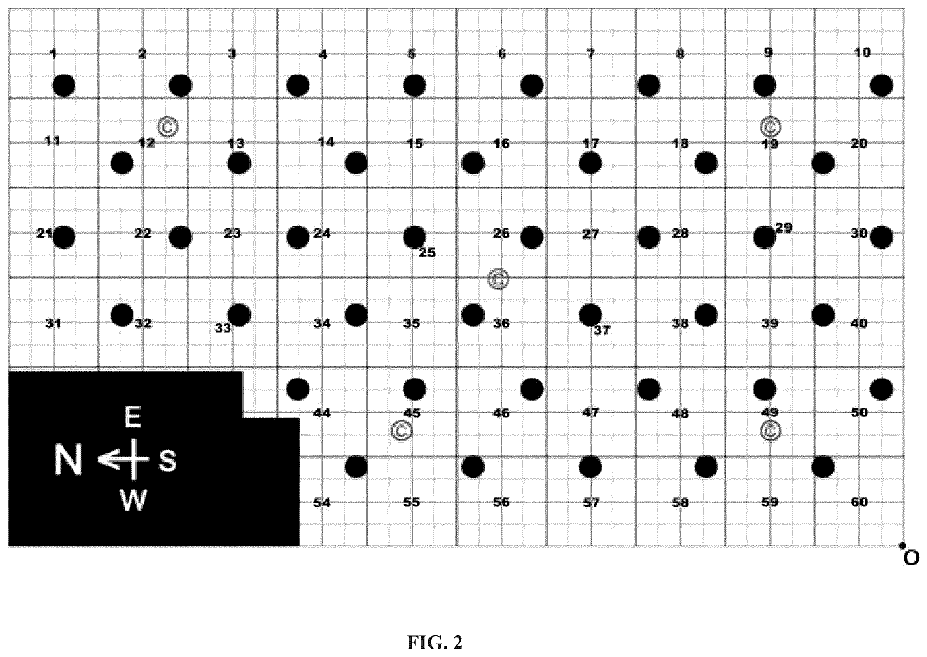

In this embodiment, the objects are stored in a warehouse having the layout shown in FIG. 2. As can be seen, the warehouse space is divided into sixty (60) virtual zones, which are provided to enable reference to the physical locations of particular components located in the warehouse, including various cameras (each of which is shown as a “C” within a circle) and various radio frequency identification (RFID) readers (each of which is shown as a black dot). Of course, the actual warehouse space is not divided into such zones. It should be understood that the warehouse layout shown in FIG. 2 is merely an example used to describe one implementation of the present invention, and that other implementations may involve warehouses having different layouts, dimensions, etc.

In this embodiment, there are five (5) cameras mounted near the ceiling of the warehouse—these cameras correspond to cameras 140₁-140ₙ shown in FIG. 1, as described below. The physical location of each camera may be described in relation to both the virtual zone in which the camera is located and the distance of the camera from an origin point O located at the southwest corner of the warehouse, as provided in Table 1 below:

TABLE 1

| | | Position | Position |
|---|---|---|---|
| | | East of | North of |
| | | Origin | Origin |
| Camera | Zone | (feet) | (feet) |
| Camera 1: Northwest | 45 | 25.0 | 130.0 |
| Camera 2: Northeast | 12 | 103.0 | 190.0 |
| Camera 3: Center | 26/36 | 64.0 | 105.0 |
| Camera 4: Southwest | 49 | 25.0 | 35.0 |
| Camera 5: Southeast | 19 | 103.0 | 35.0 |

In this example, the origin point O is located on the floor of the warehouse and each of the cameras is located 13 feet above the floor. Of course, the cameras could be positioned at any number of different heights in relation to the origin point O—i.e., the height of the cameras may be a function of the height of the warehouse ceiling, the distance that the cameras can see, and other factors.

It should be understood that the number of cameras will vary between different implementations, wherein the number is dependent at least in part on the dimensions of the warehouse or other area at which the objects are stored.

Also, in this embodiment, there are forty-one (41) RFID readers mounted near the ceiling of the warehouse—these RFID readers correspond to the RFID readers 124₁-124ₙ of real-time locating system 120 shown in FIG. 1, as described below. The physical location of each RFID reader may be described in relation to both the virtual zone in which the RFID reader is located and the distance of the RFID reader from the origin point O located at the southwest corner of the warehouse, as provided in Table 2 below:

TABLE 2

| | | Position | Position |
|---|---|---|---|
| | | East of | North of |
| | | Origin | Origin |
| RFID Reader | Zone | (feet) | (feet) |
| Reader 1 | 50 | 36.0 | 9.0 |
| Reader 2 | 30 | 75.0 | 9.0 |
| Reader 3 | 10 | 114.0 | 9.0 |
| Reader 4 | 60 | 16.5 | 24.0 |
| Reader 5 | 40 | 55.5 | 24.0 |
| Reader 6 | 20 | 94.5 | 24.0 |
| Reader 7 | 49 | 36.0 | 39.0 |
| Reader 8 | 29 | 75.0 | 39.0 |
| Reader 9 | 9 | 114.0 | 39.0 |
| Reader 10 | 58 | 16.5 | 54.0 |
| Reader 11 | 38 | 55.5 | 54.0 |
| Reader 12 | 18 | 94.5 | 54.0 |
| Reader 13 | 48 | 36.0 | 69.0 |
| Reader 14 | 28 | 75.0 | 69.0 |
| Reader 15 | 8 | 114.0 | 69.0 |
| Reader 16 | 57 | 16.5 | 84.0 |
| Reader 17 | 37 | 55.5 | 84.0 |
| Reader 18 | 17 | 94.5 | 84.0 |
| Reader 19 | 46 | 36.0 | 99.0 |
| Reader 20 | 26 | 75.0 | 99.0 |
| Reader 21 | 6 | 114.0 | 99.0 |
| Reader 22 | 56 | 16.5 | 114.0 |
| Reader 23 | 36 | 55.5 | 114.0 |
| Reader 24 | 16 | 94.5 | 114.0 |
| Reader 25 | 45 | 36.0 | 129.0 |
| Reader 26 | 25 | 75.0 | 129.0 |
| Reader 27 | 5 | 114.0 | 129.0 |
| Reader 28 | 54 | 16.5 | 144.0 |
| Reader 29 | 34 | 55.5 | 144.0 |
| Reader 30 | 14 | 94.5 | 144.0 |
| Reader 31 | 44 | 36.0 | 159.0 |
| Reader 32 | 24 | 75.0 | 159.0 |
| Reader 33 | 4 | 114.0 | 159.0 |
| Reader 34 | 33 | 55.5 | 174.0 |
| Reader 35 | 13 | 94.5 | 174.0 |
| Reader 36 | 22 | 75.0 | 189.0 |
| Reader 37 | 2 | 114.0 | 189.0 |
| Reader 38 | 32 | 55.5 | 204.0 |
| Reader 39 | 12 | 94.5 | 204.0 |
| Reader 40 | 21 | 75.0 | 219.0 |
| Reader 41 | 1 | 114.0 | 219.0 |

In this example, the origin point O is located on the floor of the warehouse and each of the RFID readers is located 15 feet above the floor. Of course, the RFID readers could be positioned at any number of different heights in relation to the origin point O—i.e., the height of the RFID readers may be a function of the height of the warehouse ceiling, the distance over which an RFID reader can detect an RFID tag, and other factors.

It should be understood that the number of RFID readers will vary between different implementations, wherein the number is dependent at least in part on the dimensions of the warehouse or other area at which the objects are stored. Of course, a minimum of three (3) RFID readers are required to form a triangle in order to determine three-dimensional location data for each object, as is known in the art, while the maximum number of RFID readers could be as many as ten thousand (10,000) or more in certain implementations.

Referring back to FIG. 1, warehouse management system 110 is provided to record the arrival of objects for storage at the warehouse and the departure of such objects from the warehouse. Each object stored in the warehouse may comprise an individual item, a group of items, a pallet of items, and the like. Upon the arrival of an object, an operator uses a handheld scanner to scan the label attached to the object and upload the scanned data to warehouse management system 110. Alternatively, object data may be manually input into warehouse management system 110, such as in cases where the object does not include a label, the label is torn or otherwise damaged, or the label does not contain all of the necessary information. In this embodiment, the object data comprises an order number associated with the object (if available), a description of the object, a number of items contained in the object, a weight of the object, and tracking information for the object, although other types of object data may also be obtained. Warehouse management system 110 also generates an object identifier for the object, such as a globally unique identifier (GUID) or any other type of unique credentials, and stores the object data in association with the object identifier within a warehouse management system (WMS) database 112. The operator also creates an RFID tag that stores the object identifier and applies or otherwise attaches the RFID tag to the object. The object is then stored in the warehouse at a desired location. When the object leaves the warehouse, a departure designation may be added to the object record or the object record may be entirely deleted from WMS database 112.

Referring still to FIG. 1, real-time locating system 120 is provided to obtain three-dimensional location data for each of the objects stored in the warehouse and provide such location data to control system 130. In this embodiment, real-time locating system 120 is comprised of a real-time locating system (RTLS) server 122 in communication with a plurality of RFID readers 124₁-124ₙ, such as the RFID readers described above in connection with the warehouse layout shown in FIG. 2. Each of RFID readers 124₁-124ₙ is in communication with one or more RFID tags. For example, in FIG. 1, RFID reader 124₁ is in communication with RFID tags 126₁-126ₙ and, similarly, RFID reader 124ₙ is in communication with RFID tags 128₁-128ₙ. Of course, it should be understood that two or more RFID readers could be in communication with the same RFID tag.

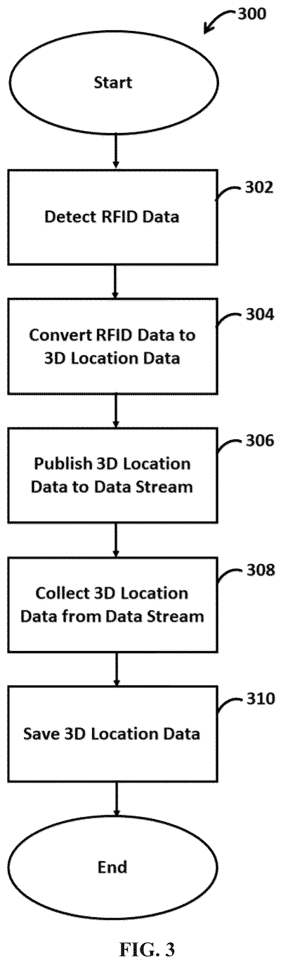

Referring to FIG. 3, a method for collecting three-dimensional location data for each of the objects stored in the warehouse in accordance with one embodiment of the present invention is shown generally as reference number 300.

In step 302, each of RFID readers 124₁-124ₙ detects the object identifier stored on each of one or more RFID tags—i.e., the RFID tags attached to objects located in proximity to the RFID reader. In one embodiment, the RFID tag receives an interrogation signal from the RFID reader(s) located in proximity to the tag and, in response, the RFID tag transmits a signal that encodes the object identifier stored on the tag back to the RFID reader(s). The RFID tag may be a passive tag that is powered by energy from the interrogation signal, or, may be an active tag that is powered by a battery or other power source. In another embodiment, the RFID tag comprises an active beacon tag in which there is no interrogation signal and the tag has its own power source. In this case, the RFID tag generates a signal that encodes the object identifier stored on the tag and transmits the signal to the RFID reader(s) in proximity to the tag. Each of RFID readers 124₁-124ₙ then transmit the detected object identifier(s) to RTLS server 122.

In step 304, RTLS server 122 executes an object locator application that analyzes the object identifiers received from RFID readers 124₁-124ₙ in order to determine the object location associated with each object identifier. The object location comprises three-dimensional location data, e.g., a set of three-dimensional Cartesian coordinates (Xₒ, Yₒ, Zₒ) representative of the position of the object relative to a reference position within a viewing region, such as the origin point O located at the southwest corner of the warehouse shown in FIG. 2. In this embodiment, each of RFID readers 124₁-124ₙ comprises an ATR7000 Advanced Array RFID Reader and the object locator application executed on RTLS server 122 comprises the CLAS software suite (version 2.2.45.99), both of which are available from Zebra Technologies Corp. of Lincolnshire, Illinois.

It should be understood that the present invention is not limited to the use of RFID technology for obtaining the three-dimensional location data. In other embodiments, other wireless technologies are used to identify and locate the objects stored in the warehouse, such as Near-Field Communication (NFC), Bluetooth, ZigBee, Ultra-Wideband (UWB), or any other short-range wireless communication technology known in the art.

In step 306, RTLS server 122 publishes a data stream that includes the object location associated with each object identifier. In this embodiment, RTLS server 122 utilizes a message broker to publish the data stream, such as the Kafka message broker developed by the Apache Software Foundation. The data stream is published continuously in this embodiment, but the data could be transmitted from RTLS server 122 to control system 130 at designated time intervals in accordance with the present invention. It should be understood that the frequency of message transmission will vary between different object identifiers-dependent on how often each object identifier is picked up by an RFID reader. Typically, an object identifier and its associated object location is published every two seconds, although the frequency could be as high as several times a second.

In step 308, web server 132 collects the data from the data stream published by RTLS server 122, i.e., the data stream with the object locations and associated object identifiers. In this embodiment, web server 132 utilizes a message collector that connects to the message broker and “taps” into the data stream to collect the data, such as the Kafka message collector developed by the Apache Software Foundation. Web server 132 then transmits the collected data to database server 134.

In step 310, database server 134 maintains an object location database 136 that stores each object location and associated object identifier. In this embodiment, database server 134 only updates object location database 136 when a new object location and associated object identifier is detected, or, when the object location associated with an existing object identifier changes. For example, if there are 10,000 messages in the data stream but the object location associated with an existing object identifier is always the same, no update is made to object location database 136. Certain messages may also be filtered out, e.g., messages picked up by the RFID readers from other sources (i.e., noise) that is not tracked by the system.

In this embodiment, web server 132 and database server 134 may be co-located in the same geographic location or located in different geographic locations and connected to each other via communications network 160. It should also be understood that other embodiments may not include both of these servers, e.g., web server 132 could be used to maintain the databases such that database server 134 is not required. Further, other embodiments may include additional servers that are not shown in FIG. 1, e.g., the applications stored in web server 132 could be stored on a separate application server. Thus, control system 130 may be implemented with any number and combination of servers, including web servers, application servers, and database servers, which are either co-located or geographically dispersed.

Referring still to FIG. 1, web server 132 communicates with a plurality of cameras 140₁-140ₙ, such as the cameras described above in connection with the warehouse layout shown in FIG. 2, via communications network 160. In this embodiment, each camera comprises a pan-tilt-zoom (PTZ) camera that is configured to broadcast a video stream of the scene within its field of view. The camera may be automatically adjusted between different fields of view each of which is characterized by a set of pan-tilt-zoom coordinates. Thus, web server 132 is able to remotely control the camera by transmitting a set of pan-tilt-zoom coordinates to the camera. The pan-tilt-zoom coordinates include a pan coordinate that determines the horizontal movement of the camera (i.e., pan left or right), a tilt coordinate that determines the vertical movement of the camera (i.e., tilt up or down), and a zoom coordinate that determines the level of optical zoom. It should be understood that other types of cameras may also be used, such as an electronic pan-tilt-zoom (ePTZ) camera or any other camera that is capable of being remotely controlled with a set of pan-tilt-zoom coordinates. A PZT camera that is suitable for use with the present invention is the AXIS Q6315-LE PTZ Network Camera available from Axis Communications AB of Lund, Sweden.

Database server 134 maintains a camera location database 138 that stores camera data associated with each of cameras 140₁-140ₙ. The camera data may comprise, for example, the location of the camera and the Uniform Resource Locator (URL) at which the camera can be accessed via communications network 160. In this embodiment, the camera location comprises three-dimensional location data, e.g., a set of three-dimensional Cartesian coordinates (X_{c}, Y_{c}, Z_{c}) representative of the position of the camera relative to a reference position within a viewing region, such as the origin point O located at the southwest corner of the warehouse shown in FIG. 2. Of course, other types of camera data may also be stored in accordance with the present invention.

Referring still to FIG. 1, web server 132 also communicates with a plurality of computing devices 150₁-150ₙ via communications network 160. Each computing device may comprise, for example, a smartphone, a personal computing tablet, a smart watch, a personal computer, a laptop computer, or any other suitable computing device known in the art. In this embodiment, each computing device utilizes an Internet-enabled application (e.g., a web browser or installed application) to communicate with web server 132. The Internet-enabled application allows the computing device to send requests to web server 132, and web server 132 responds by providing data that enables the Internet-enabled application to display various user interfaces on the computing device, as described below. Web server 132 may communicate with each computing device via Hypertext Transfer Protocol (HTTP) (e.g., HTTP/1.0, HTTP/1.1 plus, HTTP/2, or HTTP/3), Hypertext Transfer Protocol Secure (HTTPS), or any other network protocol used to distribute data and web pages.

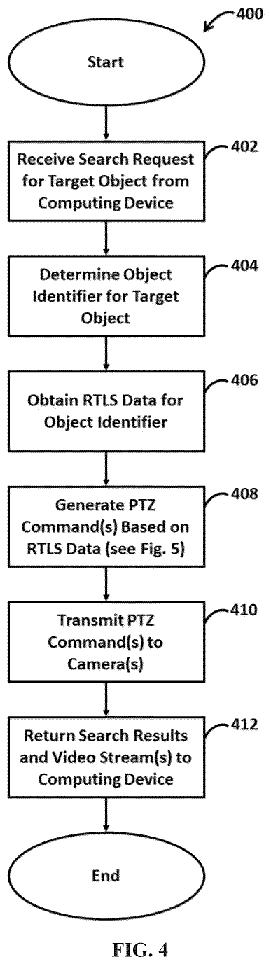

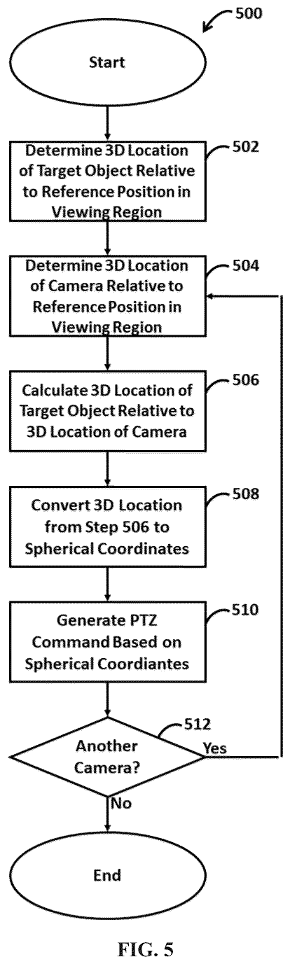

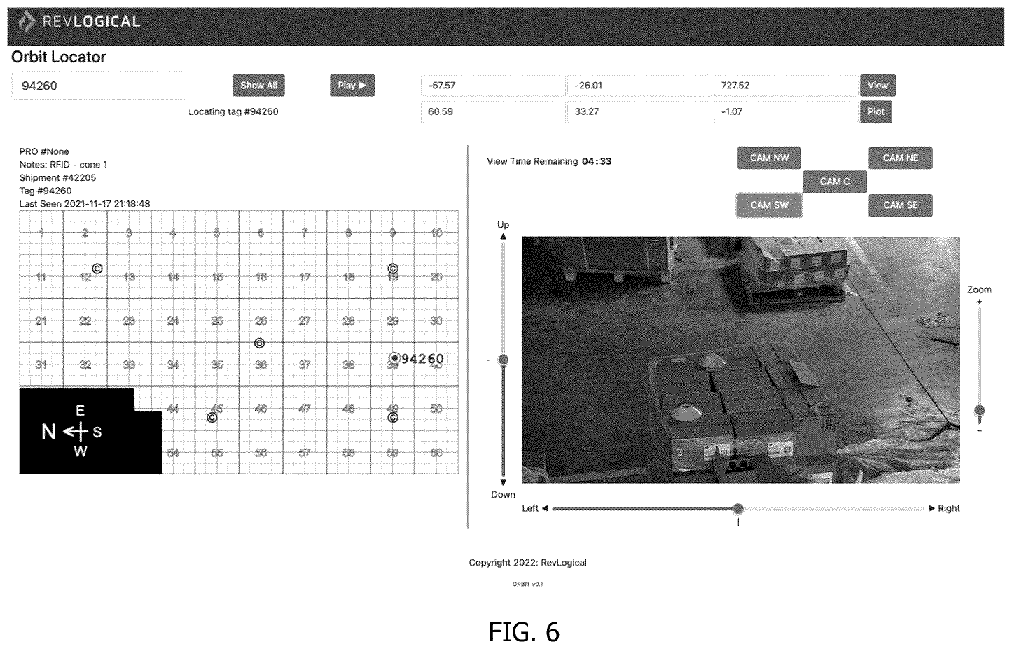

In this embodiment, each of computing devices 150₁-150ₙ is able to access web server 132 and submit a request to view a target object stored in the warehouse and, in response, web server 132 automatically controls one or more of cameras 140₁-140ₙ so as to provide a video stream that includes the target object to the computing device. This process will be described in greater detail below in connection with the flow charts shown in FIGS. 4 and 5 and the screen shot shown in FIG. 6.

Referring to FIG. 4, a method for processing a request to locate and view a target object stored in the warehouse in accordance with one embodiment of the present invention is shown generally as reference number 400.

In step 402, web server 132 receives a search request for a target object from a computing device. In one embodiment, a user uses the computing device to access a website hosted by web server 132 (e.g., by entering the website's URL into a web browser). In response, web server 132 generates and returns a web page with a user interface that allows the user to enter a search query for the target object on the computing device. An example of the web page is shown in FIG. 6. In this example, the user enters the locating tag number “94260” into the locator box positioned in the upper-left corner of the web page. In other cases, the user may enter a description of the target object into the locator box, e.g., the keywords “Sony 60 inch TV”.

In step 404, web server 132 determines the object identifier for the target object. In this embodiment, if the user has entered a locating tag number into the search query box, the object identifier is the same as the locating tag number. In other embodiments, the tag locating number and object identifier may be different unique identifiers, in which case web server 132 must access WMS database 112 to locate a match for the search query. If the user has entered a description of the target object into the search query box, web server 132 accesses WMS database 112 to locate a match for the search query. If there is more than one possible match, web server 132 presents the possible matches on the web page so that the user may select the appropriate object for viewing. Web server 132 then retrieves the object identifier associated with the selected object.

In step 406, web server 132 determines the location of the target object. To do so, web server accesses object location database 136 to identify the object location associated with the object identifier—i.e., the object location provided by real-time-locating system 120, as described above. In this embodiment, the object location comprises a set of three-dimensional Cartesian coordinates (Xₒ, Yₒ, Zₒ) representative of the position of the target object relative to the origin point O located at the southwest corner of the warehouse shown in FIG. 2.

In step 408, web server 132 generates a pan-tilt-zoom command for each of cameras 140₁-140ₙ based on the object location obtained in step 406. For each camera, web server accesses camera location database 138 to identify the camera location and URL associated with the camera. In this embodiment, the camera location comprises a set of three-dimensional Cartesian coordinates (X_{c}, Y_{c}, Z_{c}) representative of the position of the camera relative to the origin point O located at the southwest corner of the warehouse shown in FIG. 2. Web server then uses the object location and camera location to generate the pan-tilt-zoom command for that camera. The process of generating the pan-tilt-zoom command for each camera will be described below in connection with the flow chart shown in FIG. 5. It should be understood that some implementations will only involve one camera, in which case step 408 (and steps 410 and 412 described below) would only be performed in connection with a single camera.

In step 410, web server 132 transmits the applicable pan-tilt-zoom command to the URL associated with each of cameras 140₁-140ₙ i.e., each camera receives its own set of pan-tilt-zoom coordinates to cause automatic adjustment of the camera to a field of view that includes the target object. Thus, the camera, responsive to receipt of the pan-tilt-zoom command, is automatically adjusted to broadcast a video stream of a space that includes the target object.

In step 412, web server 132 returns the search results to the computing device. For example, on the web page shown in FIG. 6, the search results include am image of the warehouse layout positioned on the left side of the web page. As can be seen, the image includes the positions of the five cameras, as described above in connection with FIG. 2, as well as the position of the target object (i.e., the dot labelled “94260”). The search results also include a video stream of a selected camera on the right side of the web page. There are selection buttons that enable the user to view the video stream from any one of the five cameras (CAM NW, CAM SW, CAM C, CAM NE, CAM SE) and, in this case, the user has selected CAM SW. Thus, the video stream shown in FIG. 6 is the video stream from CAM SW. Of course, the user can select different cameras to obtain different views of the target object. It is important to note that the cameras are automatically adjusted to capture the target object without any human control of the cameras—i.e., the user is presented with the video stream from each camera in response to entry of the search query in step 402. Of course, manual adjustment bars may be provided, as shown in FIG. 6, to enable fine tuning of the pan, tilt and zoom coordinates for the selected camera.

The search results also include “View” and “Plot” information positioned at the top of the web page. The “View” information comprises the pan-tilt-zoom coordinates provided to the selected camera. As such, the “View” information will change when the user selects a different camera. The “Plot” information comprises the location of the target object within the warehouse space i.e., the three-dimensional Cartesian coordinates (Xₒ, Yₒ, Zₒ) representative of the position of the target object relative to the origin point O located at the southwest corner of the warehouse shown in FIG. 2. As such, the “Plot” information will not change when the user selects a different camera because the position of the target object is fixed.

The search results further include the “View Time Remaining” for the user. In this example, a user is given a set amount of viewing time (e.g., five minutes). If additional view requests from other users are queued, the next user is given access to the cameras after the viewing time for the current user has expired. It should be understood that the requests may be processed in any desired order, such as first in, first out (FIFO), although certain users could be provided with priority access rights that enable them to skip the queue.

One skilled in the art will understand that the web page shown in FIG. 6 is merely an example and that many different web page layouts may be provided in accordance with the present invention.

Referring to FIG. 5, a method for converting three-dimensional location data for a target object to a pan-tilt-zoom command that enables a camera to broadcast a video stream of the target object in accordance with one embodiment of the present invention is shown generally as reference number 500.

In step 502, web server 132 determines the location of the target object relative to a reference position within a viewing region. In this embodiment, the object location comprises a set of three-dimensional Cartesian coordinates (Xₒ, Yₒ, Zₒ) representative of the position of the target object relative to the origin point O located at the southwest corner of the warehouse shown in FIG. 2.

In step 504, web server 132 determines the location of the camera relative to a reference position within a viewing region. In this embodiment, the camera location comprises a set of three-dimensional Cartesian coordinates (X_{c}, Y_{c}, Z_{c}) representative of the position of the camera relative to the origin point O located at the southwest corner of the warehouse shown in FIG. 2.

In step 506, web server 132 determines the location of the target object relative to the location of the camera—i.e., the object location is redefined so that the camera location is the origin point (0, 0, 0). In this embodiment, the object location is translated relative to the camera location to determine a set of three-dimensional Cartesian coordinates (X, Y, Z), wherein the relative X, Y and Z object coordinates are calculated as follows:

X=Xₒ−X_{c} (1)

Y=Yₒ−Y_{c} (2)

Z=Zₒ−Z_{c} (3)

In step 508, web server 132 converts the set of three-dimensional Cartesian coordinates (X, Y, Z) calculated in step 506 to a set of spherical coordinates (r, θ, φ). It should be noted that the spherical coordinates (r, θ, φ) are defined using a mathematical convention (as opposed to a physics convention as specified by ISO standard 80000-2:2019) in which the camera position is the origin point (0, 0, 0) of an imaginary sphere with the object position located on the surface of the sphere. The spherical coordinates are defined as follows: (1) r is the radial distance between the camera position and the object position; (2) θ is the azimuthal angle between the camera position and the object position (i.e., θ is the number of degrees of rotation in the X-Y plane); and (3) φ is the inclination angle between the camera position and the object position (i.e., φ is the number of degrees of rotation in the X-Z plane).

In this embodiment, the radial distance (r) between the camera position and the object position is calculated as follows:

r=\sqrt{(X²+Y²+Z²)} (4)

Because the camera position is now the origin point (0, 0, 0) of the imaginary sphere, the radial distance (r) is the radius of that imaginary sphere. It will be seen that the radial distance (r) is used to determine the zoom instruction for the camera.

The azimuthal angle (θ) between the camera position and the object position is calculated as follows:

θ=arctan(Y/X) (5)

It should be noted that if either X=0 or Y=0, then the azimuthal angle (θ) is set to 0.

Because the camera position is now the origin point (0, 0, 0) of the imaginary sphere, the azimuthal angle (θ) is the arctangent of the relative Y object coordinate divided by the relative X object coordinate. It will be seen that the azimuthal angle (θ) is used to determine the pan instruction for the camera.

The inclination angle (φ) between the camera position and the object position is calculated as follows:

φ=arccos(Z/r) (6)

Because the camera position is now the origin point (0, 0, 0) of the imaginary sphere, the inclination angle (φ) is the arccosine of the relative Z object coordinate divided by the radial distance (r) calculated in equation (4) above. It will be seen that the inclination angle (φ) is used to determine the tilt instruction for the camera.

In step 510, web server 132 generates a pan-tilt-zoom command for the camera based on the set of spherical coordinates (r, θ, φ). Because the camera position is the origin point (0, 0, 0) of an imaginary sphere with the object position located on the surface of the sphere, the set of spherical coordinates (r, θ, φ) can be directly translated to a set of pan-tilt-zoom instructions for transmission to the camera.

The pan instruction (P) for the camera is defined by an angle between −359.99 degrees to 359.99 degrees. The pan instruction (P) is based on the azimuthal angle (θ) between the camera position and the object position as calculated in equation (5), with a possible offset that accounts for the position of the camera relative to the position of the object. The adjusted azimuthal angle (θ′) is determined using the following logic:

If X<0,

θ′=180°−θ

Else if Y<0,

θ′=360°+θ

Else

θ′=θ

The pan instruction (P) is then calculated as follows:

P=270°−θ′ (7)

The tilt instruction (T) for the camera is defined by an angle between −10 degrees (slightly above the camera “horizon”) and 90 degrees (directly below the camera). The tilt instruction (T) is based on the inclination angle (φ) between the camera position and the object position as calculated in equation (6), with an offset of −90 degrees that accounts for the position of the camera relative to the position of the object. The tilt instruction (T) is calculated as follows:

T=φ−90° (8)

Also, the tilt instruction (T) may need to be adjusted to account for the orientation of the camera within the contained area. Specifically, if the camera is positioned upside down (i.e., not upright), then the tilt instruction (T) must be multiplied by a factor of −1.0.

The zoom instruction (Z) for the camera is based on the radial distance (r) between the camera position and the object position as calculated in equation (4), where r is converted logarithmically to a scale between 1 and 9999 using a zoom factor (f). The zoom factor (f) will change given the size of the warehouse or other contained area, the number of cameras, etc. (the closer the object is to the camera, the lower the zoom). For a given zoom factor (f), the zoom instruction (Z) is calculated as follows:

Z=r^{f} (9)

Finally, in step 512, web server 132 determines if there is another camera to be controlled. If so, the process returns to step 504 so that the pan-tilt-zoom coordinates may be determined for that camera. However, if there are no additional cameras, the process ends.

### Example

An example will now be provided to illustrate the application of equations (1)-(9) in connection with the performance of steps 508 and 510. Assume that the set of three-dimensional Cartesian coordinates for the camera (X_{c}, Y_{c}, Z_{c}) is (10, 10, 10) and the set of three-dimensional Cartesian coordinates (Xₒ, Yₒ, Zₒ) for the target object is (8, 8, 0). The location of the target object relative to the location of the camera can be calculated from equations (1)-(3), as follows:

X=Xₒ−X_{c}=8−10=−2

Y=Yₒ−Y_{c}=8−10=−2

Z=Zₒ−Z_{c}=0−10=−10

The radial distance (r) between the camera position and the object position can be calculated from equation (4), as follows:

r=\sqrt{(X²+Y²+Z²)}=\sqrt{(−22+−22+−10²)}=10.39

The azimuthal angle (θ) between the camera position and the object position can be calculated from equation (5), as follows:

θ=arctan(Y/X)=arctan(−2/−2)=45.00°

The inclination angle (φ) between the camera position and the object position can be calculated from equation (6), as follows:

φ=arccos(Z/r)=arccos(−10/10.39)=164.24°

Thus, the spherical coordinates (r, θ, φ) in this example are (10.39, 45.00, 164.24).

The pan instruction (P) for the camera can be calculated from equation (7) using an adjusted azimuthal angle (θ′) of 135.00 degrees (i.e., 180−45.00, because X<0), as follows:

P=270°−θ′=270°−135.00°=135.00°

The tilt instruction (T) for the camera can be calculated from equation (8), as follows:

T=φ−90°=164.24−90°=74.24°

In this example, the camera is positioned upside down. Thus, the tilt instruction (T) is multiplied by a factor of −1.0, i.e., the tilt instruction (T) is actually −74.24 degrees.

The zoom instruction (z) for the camera can be calculated from equation (9) assuming a zoom factor (f) of 2, as follows:

Z=r^{f}=10.39²=107.95

Thus, the PTZ instructions (P, T, Z) in this example are (135.00, −74.24, 107.95) i.e., pan 135.00 degrees, tilt down 74.24 degrees, and zoom 107.95 units away.

### GENERAL INFORMATION

The description set forth above provides several exemplary embodiments of the inventive subject matter. Although each exemplary embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The use of any and all examples or exemplary language (e.g., “such as” or “for example”) provided with respect to certain embodiments is intended merely to better describe the invention and does not pose a limitation on the scope of the invention. No language in the description should be construed as indicating any non-claimed element essential to the practice of the invention.

The use of the terms “comprises,” “comprising,” or any other variation thereof, are intended to cover a non-exclusive inclusion, such that a system or method that comprises a list of elements does not include only those elements, but may include other elements not expressly listed or inherent to such system or method.

Finally, while the present invention has been described and illustrated hereinabove with reference to various exemplary embodiments, it should be understood that various modifications could be made to these embodiments without departing from the scope of the invention. Therefore, the present invention is not to be limited to the specific systems or methods of the exemplary embodiments, except insofar as such limitations are included in the following claims.

What is claimed and desired to be secured by Letters Patent is as follows:

1. An automated camera system for broadcasting video streams of target objects located in a warehouse, comprising:
at least one camera positioned within the warehouse; and
a control system in communication with the camera, wherein the control system is configured to:
receive a request to view a target object located in the warehouse;
determine a set of three-dimensional Cartesian coordinates representative of a first position of the target object relative to a second position of the camera;
convert the set of three-dimensional Cartesian coordinates to a set of spherical coordinates;
generate a pan-tilt-zoom command based on the set of spherical coordinates; and
transmit the pan-tilt-zoom command to the camera;
wherein the camera, responsive to receipt of the pan-tilt-zoom command, is automatically adjusted to broadcast a video stream of the target object.

2. The system of claim 1, wherein the camera comprises a pan-tilt-zoom (PTZ) camera.

3. The system of claim 1, wherein the camera comprises an electronic pan-tilt-zoom (ePTZ) camera.

4. The system of claim 1, wherein the camera is configured for automatic adjustment between a plurality of fields of view each of which is characterized by a set of pan-tilt-zoom coordinates, and wherein the pan-tilt-zoom command includes the set of pan-tilt-zoom coordinates for a field of view that includes the target object.

5. The system of claim 1, wherein the control system is configured to receive the request to view the target object from a computing device located remote from the warehouse, and wherein the video stream is provided to the computing device.

6. The system of claim 5, wherein the control system is configured to provide a user interface for display on the computing device that enables a user to adjust a field of view of the camera.

7. The system of claim 1, wherein the control system is configured to determine the set of three-dimensional Cartesian coordinates based on (i) a first set of three-dimensional Cartesian coordinates representative of the first position of the target object relative to a reference position within a viewing region and (ii) a second set of three-dimensional Cartesian coordinates representative of the second position of the camera relative to the reference position within the viewing region.

8. The system of claim 7, wherein the control system is configured to receive the first set of three-dimensional Cartesian coordinates from a real time locating system.

9. The system of claim 7, wherein the control system includes a database that stores the first set of three-dimensional Cartesian coordinates in relation to an object identifier for the target object, and wherein the control system is configured to
determine the object identifier for the target object based on the request to view the target object; and
access the database to determine the first set of three-dimensional Cartesian coordinates associated with the object identifier.

10. The system of claim 1, wherein the pan-tilt-zoom command includes a pan instruction, a tilt instruction, and a zoom instruction.

11. The system of claim 10, wherein the pan instruction is based on an azimuthal angle between the second position of the camera and the first position of the target object, wherein the tilt instruction is based on an inclination angle between the second position of the camera and the first position of the target object, and wherein the zoom instruction is based on a radial distance between the second position of the camera and the first position of the target object.

12. An automated camera system, comprising:
a camera configured for automatic adjustment between a plurality of fields of view; and
a control system in communication with the camera, wherein the control system is configured to:
determine a first set of three-dimensional Cartesian coordinates representative of a first position of a target object relative to a reference position within a viewing region;
determine a second set of three-dimensional Cartesian coordinates representative of a second position of the camera relative to the reference position within the viewing region;
determine a third set of three-dimensional Cartesian coordinates representative of the first set of three-dimensional Cartesian coordinates relative to the second set of three-dimensional Cartesian coordinates;
convert the third set of three-dimensional Cartesian coordinates to a set of spherical coordinates;
generate a camera command based on the set of spherical coordinates; and
transmit the camera command to the camera;
wherein the camera, responsive to receipt of the camera command, is automatically adjusted to provide a field of view that includes the target object.

13. The system of claim 12, wherein the camera comprises a pan-tilt-zoom (PTZ) camera.

14. The system of claim 12, wherein the camera comprises an electronic pan-tilt-zoom (ePTZ) camera.

15. The system of claim 12, wherein the control system is configured to receive the first set of three-dimensional Cartesian coordinates from a real time locating system.

16. The system of claim 12, wherein the control system includes a database that stores the first set of three-dimensional Cartesian coordinates in relation to an object identifier for the target object, and wherein the control system is configured to:
receive a request to view the target object;
determine the object identifier for the target object based on the request to view the target object; and
access the database to determine the first set of three-dimensional Cartesian coordinates associated with the object identifier.

17. The system of claim 12, wherein each of the fields of view is characterized by a set of pan-tilt-zoom coordinates, and wherein the camera command includes the set of pan-tilt-zoom coordinates for the field of view that includes the target object.

18. The system of claim 12, wherein the camera command includes a pan instruction, a tilt instruction, and a zoom instruction.

19. The system of claim 18, wherein the pan instruction is based on an azimuthal angle between the second position of the camera and the first position of the target object, wherein the tilt instruction is based on an inclination angle between the second position of the camera and the first position of the target object, and wherein the zoom instruction is based on a radial distance between the second position of the camera and the first position of the target object.

20. The system of claim 12, wherein the camera is configured to broadcast a video stream that includes the target object.

21. The system of claim 12, wherein the camera and the target object are located in a warehouse.

22. A method of automatically controlling a camera to provide a video stream of a target object, comprising:
determining a set of three-dimensional Cartesian coordinates representative of a first position of the target object relative to a second position of the camera;
converting the set of three-dimensional Cartesian coordinates to a set of spherical coordinates;
generating a camera command based on the set of spherical coordinates; and
transmitting the camera command to the camera whereby the camera is automatically adjusted to broadcast a video stream of the target object.

23. The method of claim 22, wherein the camera comprises a pan-tilt-zoom (PTZ) camera.

24. The method of claim 22, wherein the camera comprises an electronic pan-tilt-zoom (ePTZ) camera.

25. The method of claim 22, wherein the camera is configured for automatic adjustment between a plurality of fields of view each of which is characterized by a set of pan-tilt-zoom coordinates, and wherein the camera command includes the set of pan-tilt-zoom coordinates for a field of view that includes the target object.

26. The method of claim 22, further comprising:
receiving a request to view the target object from a computing device; and
providing the video stream to the computing device.

27. The method of claim 22, wherein determining the set of three-dimensional Cartesian coordinates is based on (i) a first set of three-dimensional Cartesian coordinates representative of the first position of the target object relative to a reference position within a viewing region and (ii) a second set of three-dimensional Cartesian coordinates representative of the second position of the camera relative to the reference position within the viewing region.

28. The method of claim 27, further comprising receiving the first set of three-dimensional Cartesian coordinates from a real time locating system.

29. The method of claim 22, wherein the camera command includes a pan instruction, a tilt instruction, and a zoom instruction.

30. The method of claim 29, wherein the pan instruction is based on an azimuthal angle between the second position of the camera and the first position of the target object, wherein the tilt instruction is based on an inclination angle between the second position of the camera and the first position of the target object, and wherein the zoom instruction is based on a radial distance between the second position of the camera and the first position of the target object.
